(19) United States
(12) Patent Application Publication
(10) Pub. No.: US 2008/0163498 A1
(43) Pub. Date: Jul. 10, 2008

(54) Apparatus for Preparing a Beverage

(76) Inventors: Lior Masheah, Kfar Saba (IL); Meir Gitelis, Moshav Bnei Atarot (IL); Ora Masheah, Plymouth, MN (US)

Correspondence Address: HAIM FACTOR;Ofek Group Inc., 16192 Coastal Highway, Lewes, DE, 19958, US

(21) Appl. No.: 11/944,439

(22) Filed: Nov. 22, 2007

Related U.S. Application Data
(60) Provisional application No. 60/883,823, filed on Jan. 8, 2007.

(51) Int. Cl. A47J 43/28

(52) U.S. Cl. 30/326; 30/327

(57) ABSTRACT

The present invention is directed to an apparatus for preparing beverage, the apparatus comprising: a spoon, such as teaspoon, soupspoon, and the like; a bag, for storing extract for preparing the beverage; and means for attaching the bag to the bowl of the spoon. The bag may be deployed at the concave side of the spoon, and/or at the convex side of the spoon. The apparatus may further comprise a hook, for hooking the apparatus on the rim of a glass. The apparatus may further comprise a clip, for attaching the apparatus to the walls of a glass. The apparatus may further comprise a wrapper, for keeping the extract isolated until use. The means for attaching the bag to the bowl of the spoon may comprise folded edges of the bag. The bag may be made of stiff material, thereby keeping the edges thereof folded.

The current application claims the benefit of U.S. Provisional Application No. 60/883,823, filed on Jan. 8, 2007, and incorporated herein by reference.

### FIELD OF THE INVENTION

The present invention relates to the field of beverage preparation. More particularly, the invention relates to an apparatus for preparing a beverage.

### BACKGROUND OF THE INVENTION

When one enters a restaurant and orders a hot beverage, Tea for example, he would receive together with the cup an un-sterile metal teaspoon and in addition a teabag on the side. Usually on the table a sugar holder is set out, which is also un-sterile.

Even at home when one wants to make a hot beverage, he has to get the teaspoon from one place, sugar from another place and the tea from yet another place; operations which take time.

It is an object of the present invention to provide a sterile apparatus for preparing a beverage, such as coffee, tea, cocoa, and so forth.

Other objects and advantages of the invention will become apparent as the description proceeds.

### SUMMARY OF THE INVENTION

The following embodiments and aspects thereof are described and illustrated in conjunction with systems, tools and methods, which are meant to be merely illustrative, not limiting in scope. In various embodiments, one or more of the above-described problems have been reduced or eliminated, while other embodiments are directed to other advantages or improvements.

The present invention is directed to an apparatus for preparing beverage, the apparatus comprising:
a spoon, such as teaspoon, soupspoon, and the like;
a bag, for storing extract for preparing the beverage; and
means for attaching the bag to the bowl of the spoon.

The bag may be deployed at the concave side of the spoon, and/or at the convex side of the spoon.

The apparatus may further comprise a hook, for hooking the apparatus on the rim of a glass.

The apparatus may further comprise a clip, for attaching the apparatus to the walls of a glass.

The apparatus may further comprise a wrapper, for keeping the extract isolated until use.

The apparatus may further comprise a hermetic wrapper, for keeping the extract sterile until use.

The extract, such as tea, coffee, and cocoa, may additionally comprise a sweetener.

According to one embodiment of the invention, the bag comprises a plurality of compartments, for storing a plurality of extracts.

The spoon may be made or comprise laminated cardboard, plastic, metal, and so forth.

The bag may comprise porous material, thereby allowing water to penetrate into the bag.

According to one embodiment of the invention, the means for attaching the bag to the bowl of the spoon comprises folded edges of the bag.

According to another embodiment of the invention, the bag is made of stiff material, thereby keeping the edges thereof folded.

In addition to the exemplary aspects and embodiments described above, further aspects and embodiments will become apparent by reference to the figures and by study of the following detailed description.

### BRIEF DESCRIPTION OF THE DRAWINGS

The objects and features of the present invention will become apparent from the following detailed description considered in conjunction with the accompanying drawings, in which:

FIG. 1 schematically illustrates an apparatus 2 for preparing a beverage, according to one embodiment of the invention.

FIG. 2 schematically illustrates apparatus 2 from a different point of view, from which the lower part of the apparatus is seen.

FIG. 3 is a cross section, which schematically illustrates the structure of an apparatus for preparing a beverage, according to one embodiment of the invention.

FIG. 4 schematically illustrates an apparatus 2 for preparing a beverage, according to another embodiment of the invention.

FIGS. 5a and 5b schematically illustrate a process of preparing a beverage by an apparatus thereof, according to one embodiment of the invention.

FIG. 6 schematically illustrates an apparatus for preparing beverage, which comprises a clip 40, according to one embodiment of the invention.

FIG. 7 schematically illustrates an apparatus for preparing beverage, which comprises a clip 40, according to another embodiment of the invention.

It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein. Reference numerals may be repeated among the figures in order to indicate corresponding or analogous elements.

### DETAILED DESCRIPTION OF PREFERRED EMBODIMENTS

In the following detailed description, numerous specific details are set forth in order to provide a thorough understanding of the invention. However, it will be understood by those skilled in the art that the present invention may be practiced without these specific details. In some instances, well-known methods, procedures, components and circuits have not been described in detail, for the sake of clarity.

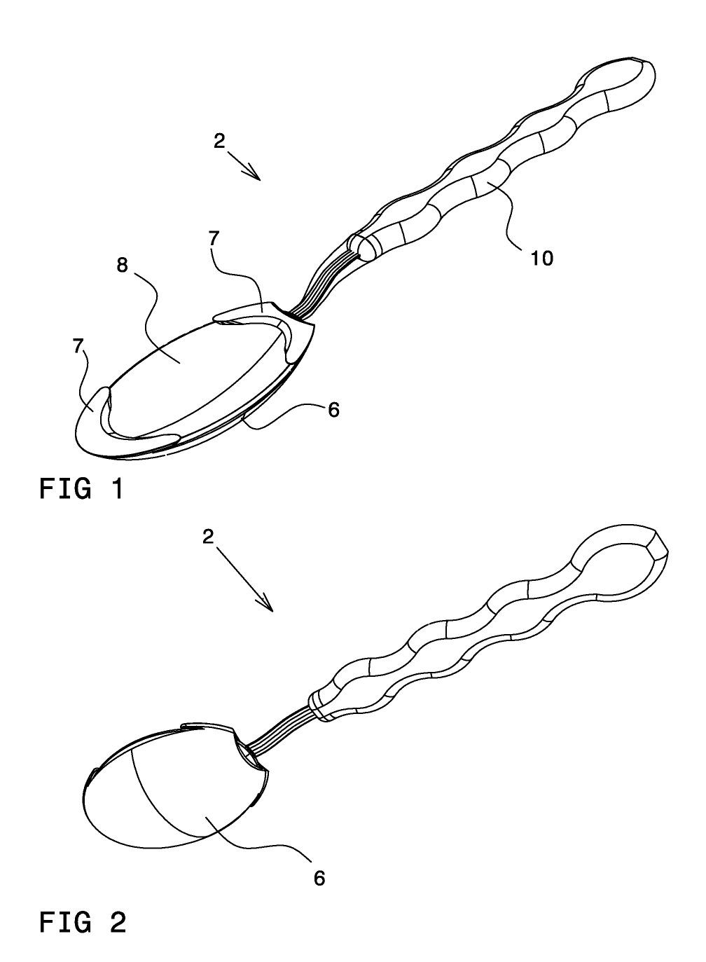

FIG. 1 schematically illustrates an apparatus 2 for preparing a beverage, according to one embodiment of the invention. FIG. 2 schematically illustrates apparatus 2 from a different point of view, from which the lower part of the apparatus is seen.

Apparatus 2 comprises a spoon (whose bowl is marked by numeral 8 and handle is marked by numeral 10), and a bag 6 secured to bowl 8. Bag 6 stores the materials used for preparing a beverage, such as coffee powder, cocoa powder, tea extract, and so forth.

Bag 6 is secured to the spoon bowel 8 by the folded edges 7.

Retaining edges 7 folded may be obtained by a plurality of means. For example, according to one embodiment of the invention, the folded edges 7 are retain folded by an adherent which adhere the edges 7 to the spoon bowl 8, and/or adhere the edges 7 to the rest of the bag 6.

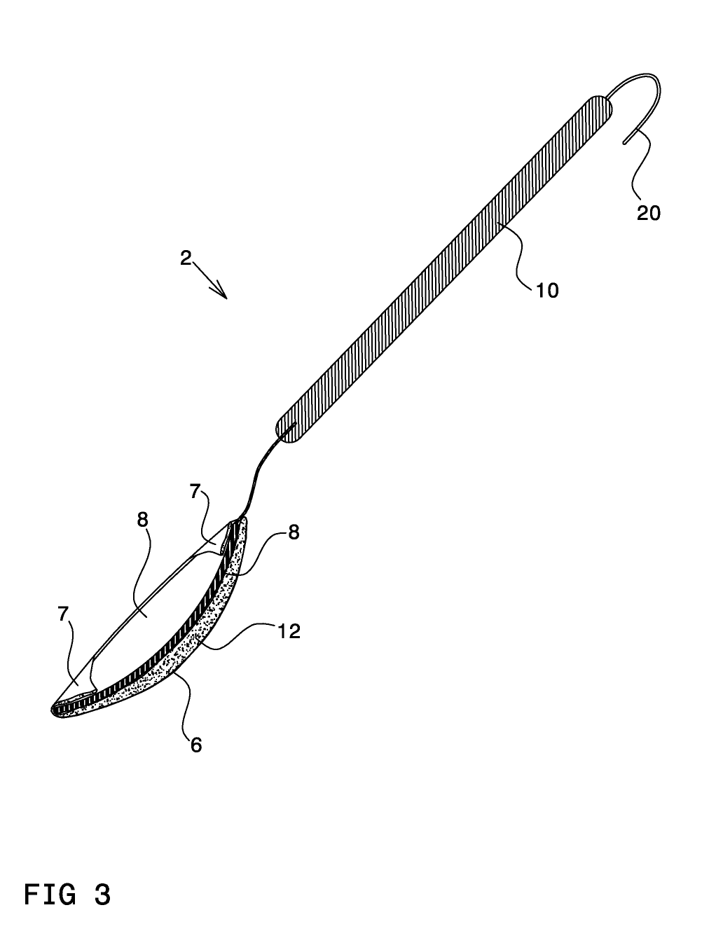

FIG. 3 is a cross section, which schematically illustrates the structure of an apparatus for preparing a beverage, according to one embodiment of the invention.

In addition to the elements illustrated in FIGS. 1 to 2, the spoon also comprises a hook 20, for hooking the spoon on the edge of a mug.

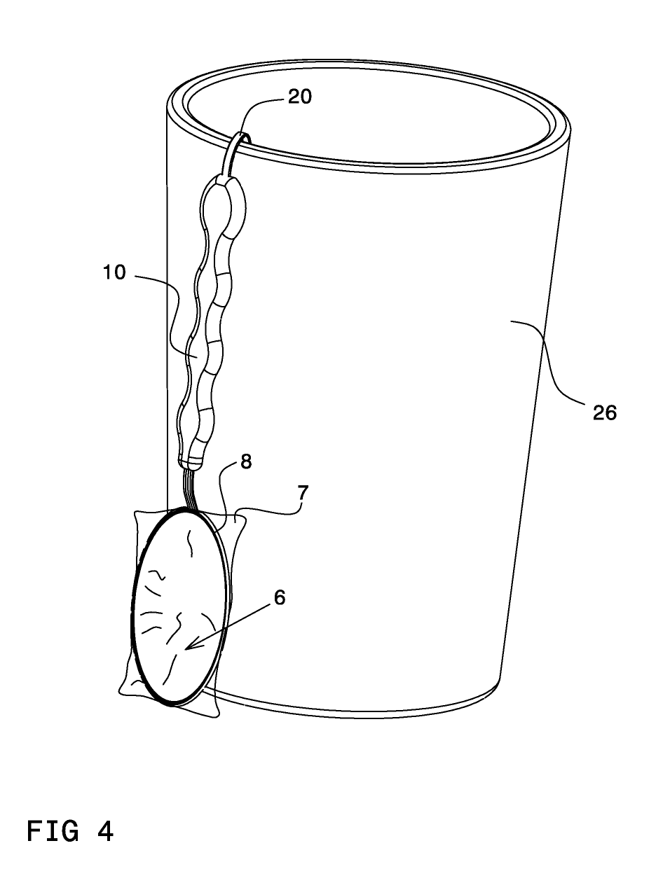

FIG. 4 schematically illustrates an apparatus 2 for preparing a beverage, according to another embodiment of the invention.

According to this embodiment of the invention, bag 6 is made of two overlapping sheets, into which bowl 8 of the spoon and the beverage substance are enclosed.

FIG. 4 also illustrates the manner in which the spoon hooks on the rim of a mug 26 by its hook 20.

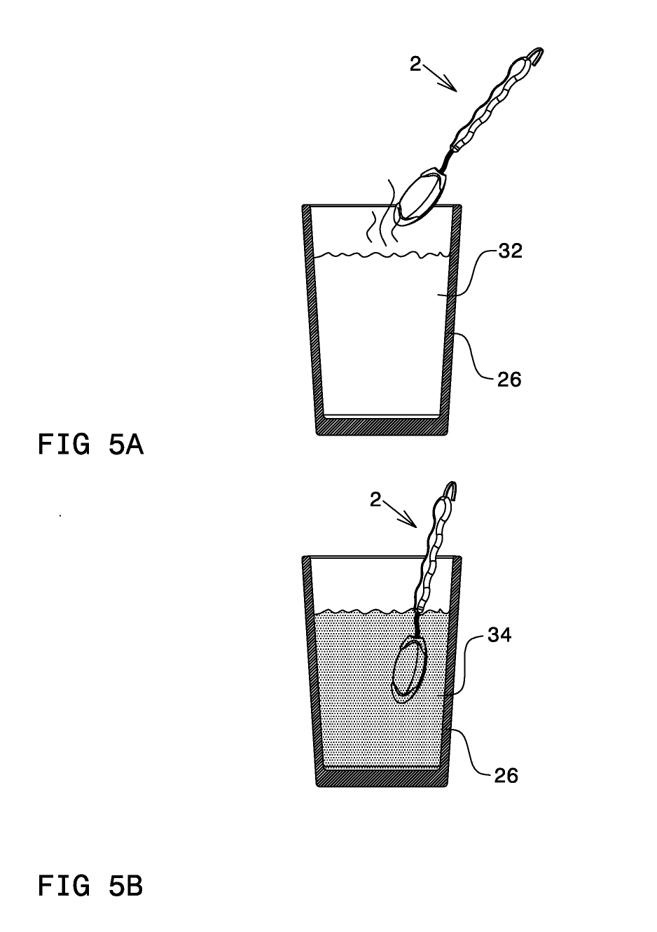

FIGS. 5a and 5b schematically illustrate a process of preparing a beverage by an apparatus thereof, according to one embodiment of the invention.

In FIG. 5a, apparatus 2 is illustrated as being inserted into the hot water 32 of glass 36. FIG. 5b illustrates the result of mixing the hot water within the glass with the substance stored within apparatus 2, e.g., tea extract. Numeral 34 denotes the prepared beverage.

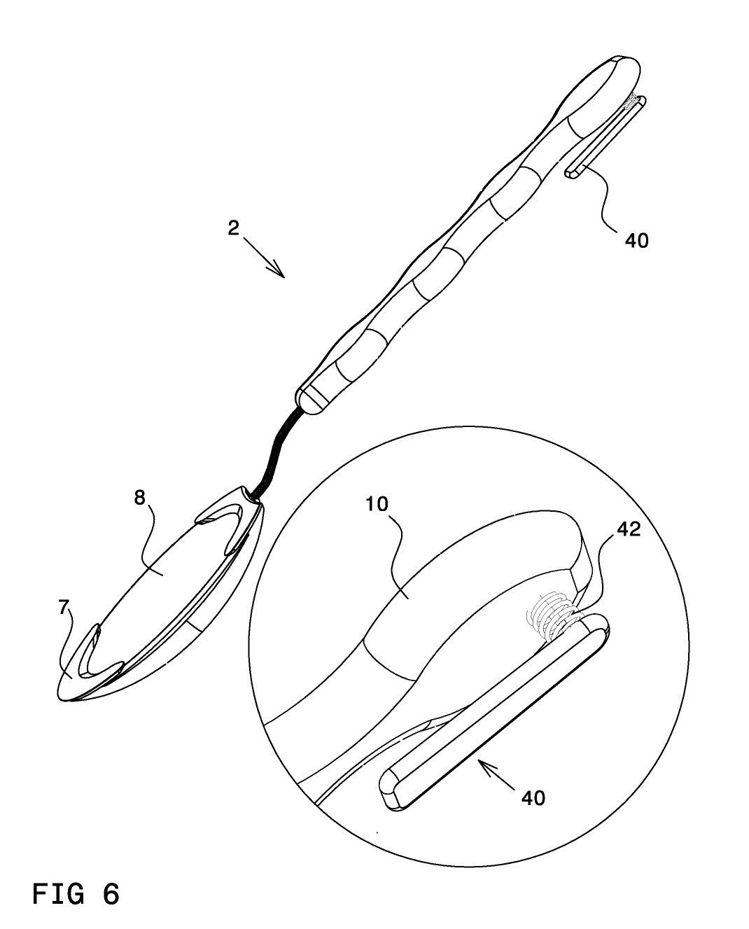

FIG. 6 schematically illustrates an apparatus for preparing beverage, which comprises a clip 40, according to one embodiment of the invention.

Using the clip for securing apparatus 2 to the walls of a glass, the user does not have to put away the apparatus 2 while drinking the beverage, but rather leave it in the glass.

This might be very useful, for example, in beverage purchased in train stations and the like, since the user does not have to through away the apparatus, until finish drinking the beverage.

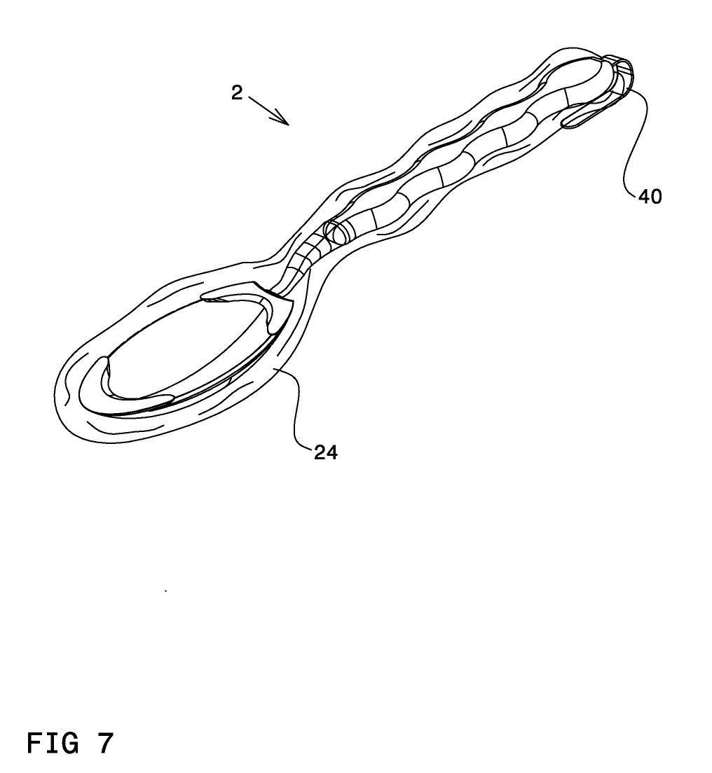

FIG. 7 schematically illustrates an apparatus for preparing beverage, which comprises a clip 40, according to another embodiment of the invention.

According to this example, clip 40 is made of elastic material, which is the substitute of the spring 42 of FIG. 6.

Also illustrated in this figure is a wrapper 24, in which the apparatus for preparing beverage is wrapped. As wrapper 24 wraps the entire apparatus for preparing beverage, it keeps it sterile assuming the wrapper is made of sealed material.

According to one embodiment of the invention, the material the bag is made of is made of porous material, thereby allowing the water of a glass to penetrate into the bag, and allowing the concentrated mixture inside the bag to seep out of the bag.

According to one embodiment of the invention (not illustrated) the extract 8 is stored into the convex side of the bowel 6 of the spoon. In this case the bag may be used as a lid.

According to one embodiment of the invention, the beverage substance (powder, extract, etc.) comprises also a sweetener, such as sugar.

According to one embodiment of the invention, the bag comprises a plurality of compartments, for storing a plurality of extracts.

In the figures and description herein, the following numerals have been mentioned:
numeral 2 denotes an apparatus for preparing a beverage;
numeral 6 denotes a bag, for storing beverage extract, powder, and so on;
numeral 7 denotes a folded edge of a bag for storing beverage extract (i.e., means for securing the bag to a spoon's bowel);
numeral 8 denotes the bowl of a spoon;
numeral 10 denotes the handle of a spoon;
numeral 12 denotes beverage extract (powder, and so on);
numeral 20 denotes a hook, for hooking an apparatus for preparing beverage to a glass;
numeral 24 denotes a wrapper;
numeral 32 denotes water;
numeral 34 denotes beverage;
numeral 36 denotes a glass;
numeral 40 denotes a clip, for securing an apparatus for preparing beverage to a glass;
numeral 42 denotes a spring.

While certain features of the invention have been illustrated and described herein, the invention can be embodied in other forms, ways, modifications, substitutions, changes, equivalents, and so forth. The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. An apparatus for preparing a beverage, the apparatus comprising:
a spoon;
a bag, for storing extract for preparing said beverage; and
means for attaching said bag to the bowl of said spoon.

2. An apparatus according to claim 1, wherein said bag is deployed at the concave side of said spoon.

3. An apparatus according to claim 1, wherein said bag is deployed at the convex side of said spoon.

4. An apparatus according to claim 1, wherein said bag is disposed at the convex side of said spoon.

5. An apparatus according to claim 1, wherein said spoon is a teaspoon.

6. An apparatus according to claim 1, wherein said spoon is a soupspoon.

7. An apparatus according to claim 1, further comprising a hook, for hooking said apparatus on the rim of a glass.

8. An apparatus according to claim 1, further comprising a clip, for attaching said apparatus to the walls of a glass.

9. An apparatus according to claim 1, further comprising a wrapper, for keeping said extract isolated until use.

10. An apparatus according to claim 1, further comprising an hermetic wrapper, for keeping said extract sterile until use.

11. An apparatus according to claim 1, wherein said extract comprises a sweetener.

12. An apparatus according to claim 1, wherein said bag comprises a plurality of compartments, for storing a plurality of extracts.

13. An apparatus according to claim 1, wherein said spoon comprises laminated cardboard.

14. An apparatus according to claim 1, wherein said spoon comprises plastic.

15. An apparatus according to claim 1, wherein said spoon comprises metal.

16. An apparatus according to claim 1, wherein said bag comprises porous material.

17. An apparatus according to claim 1, wherein said means for attaching said bag to the bowl of said spoon comprises folded edges of said bag.

18. An apparatus according to claim 17, wherein said bag is made of stiff material, thereby keeping said edges folded.
